(19) United States
(12) Patent Application Publication
(10) Pub. No.: US 2026/0091547 A1
(43) Pub. Date: Apr. 2, 2026

(54) TRANSFER DEVICE, TRANSFER STATION, THERMOFORMING SYSTEM AND METHOD FOR TRANSFERRING THERMOFORMED MOLDED PARTS

(71) Applicant: Kiefel GmbH, Freilassing (DE)

(72) Inventors: Aaron Datscher, Micheldorf (AT); Gerald Sternecker, Leonstein (AT); Michael Staudinger, Fridolfing (DE)

(21) Appl. No.: 19/345,355

(22) Filed: Sep. 30, 2025

(30) Foreign Application Priority Data
Oct. 2, 2024 (DE) 10 2024 128 674.1

(51) Int. Cl. B29C 51/26; B29C 51/44

(52) U.S. Cl. CPC B29C 51/261; B29C 51/445

(57) ABSTRACT

A transfer device for transferring parallel-arranged rows of stacked molded parts, a transfer station with a transfer device, a thermoforming system with a transfer station, and a method for transferring thermoformed molded parts are described. Thermoformed molded parts are transferred from a stacking basket to a transport unit using a transfer device. Stacked molded parts are transferred row by row from the receiving compartments of the stacking basket to a transfer device for transferring stacked molded parts via a shifting unit. The transfer device has transfer elements arranged parallel relative to one another, which in each case hold a row of stacked molded parts during a transfer to a transport unit. The transport unit has parallel-arranged receptacles for stacked molded parts. The spacing of the transfer elements relative to one another is modified after the receiving of the stacked molded parts and prior to the transfer to the transport unit.

### PRIORITY CLAIM

The present application claims priority under 35 U.S.C. § 119 to German Patent Application No. DE 10 2024 128 674.1, filed Oct. 2, 2024, the disclosure of which is incorporated by reference herein in its entirety.

### TECHNICAL FIELD

A transfer device for transferring parallel-arranged rows of stacked molded parts, a transfer station with a transfer device, a thermoforming system with a transfer station and a method for transferring thermoformed molded parts by means of a transfer device are described.

### BACKGROUND

In thermoforming systems with a tiltable mold, the formed molded parts are usually collected in a stacking basket after forming. The stacking basket has a plurality of compartments, the number and arrangement of which correspond to the cavities of a forming tool. Therefore, the molded parts are stacked from the cavities into the receiving compartments according to their arrangement. The receiving compartments are designed so that multiple molded parts can be received in each receiving compartment. If a certain number of molded parts are stacked in each receiving compartment, the stacks are pushed row by row from the receiving compartments onto transfer elements via a shifting unit.

When changing a forming tool, it may be necessary to also change the stacking basket, in particular if molded parts with modified dimensions and spacings in the cavities are formed. Accordingly, it is then also necessary to replace the transfer elements or a transfer unit, so that the stacks can be pushed from the stacking basket onto the assigned transfer elements (for example, shells). However, such an additional change involves increased effort and additional costs.

Furthermore, it is disadvantageous if transfer elements are exchanged, since the transfer elements often transfer the stacks to other devices for further processing. Transfer elements of different designs or transfer elements whose spacing relative to one another can be modified make further processing more difficult and result in high design and process-related effort. In order to ensure reliable further processing, it would therefore be advantageous to transport the stacks of molded parts in defined positions, independent of the molded-part dimensions and the spacings of the cavities of a forming tool and the receiving compartments of a stacking basket.

### SUMMARY

### Object

Thus, it is an object to provide a solution for the further transport of stacked molded parts that ensures reliable further processing, while requiring little effort and being designed in a space-saving manner. A further object is to provide an alternative solution for further transport.

### Solution

The above-mentioned object is achieved by a transfer device for transferring parallel-arranged rows of stacked molded parts, having multiple transfer elements that are arranged parallel relative to one another and are designed to in each case hold a row of stacked molded parts during a transfer, where the spacing of the transfer elements can be modified during the transfer between the receiving of rows of stacked molded parts and the transfer of rows of stacked molded parts.

The design of the transfer device with transfer elements whose spacing can be modified during the transfer makes it possible to align the transfer elements relative to one another in such a way that they exhibit the ideal, adjusted spacing for receiving stacks of molded parts from the receiving compartments of a stacking basket and can also assume a defined spacing relative to one another for further processing and transfer.

This ensures reliable further processing, where the stacked molded parts can always be transported further in a defined position.

The number of transfer elements corresponds at least to the number of receiving compartments in a row of the stacking basket. The transfer device can have more transfer elements than the number of receiving compartments in a row, so that a corresponding number of transfer elements is available for rows with a greater number of receiving compartments. However, if fewer receiving compartments are provided in a row, some of the transfer elements can remain free or not be loaded with stacks. In further embodiments, transfer elements that are not required can be removed from the transfer device. For this purpose, the transfer elements can be connected with fastening devices that make quick and easy exchange possible. For example, latchable connecting elements (including magnetic ones) or plug-in connections can be provided.

The transfer elements can be designed as shells. The length of the shells can be determined and designed according to the stacking height of different molded parts.

The advantage of the transfer device lies in particular in that it does not need to be exchanged when a mold change with a change of cavity layout (size, design, position, and spacing of the cavities) occurs. In addition, it is not necessary to modify the further transport or to provide measures that adjust to different spacings of transfer elements with stacks placed on them, so that further processing is greatly simplified.

In further embodiments, the spacing of the transfer elements can be uniformly modified, where the spacings increase or decrease but always exhibit substantially the same spacing relative to one another.

In further embodiments, the spacing of the transfer elements relative to one another can be variably modified. This offers many possibilities in terms of different cavity layouts. For example, cavities may be unevenly distributed, so that an uneven spacing of transfer elements is required for the transfer from the receiving compartments. In addition, the transfer device can also receive stacks of molded parts and pass them on to a transport unit at a defined spacing, if cavities of different designs are provided in a forming tool.

In further embodiments, a transfer device can have a cam guide, where the transfer elements in each case have a guide element (for example, a pin or the like) that is received in a corresponding guide of the cam guide, where the cam guide is displaceable in order to adjust the spacing of the transfer elements in accordance with the guides by the displacement. The displacement of the cam guide makes the displacement of the transfer elements possible, which transfer elements are mounted so as to be shiftable relative to one another, for example on a rail system or the like.

In further embodiments, the transfer device can have a cam plate that has the cam guide and is linearly displaceable via at least one actuator, or a cam drum whose surface has the cam guide and that is rotatably mounted via at least one actuator. The cam plate or the cam drum have the guides in which the guide elements of the transfer elements are received. A linear displacement of the cam plate or a rotation of the cam drum necessarily results in a displacement of the transfer elements, which can only be mounted so as to be shiftable in one direction. In the case of a cam plate, the shifting path and the length of the guides must be determined based on the available space in the transfer device in accordance with the length of the transfer elements. A cam drum has the advantage that it can be driven endlessly in only one direction of rotation and does not necessarily have to be switched between clockwise and anti-clockwise rotation. In addition, a cam drum has the advantage that it makes a wide range of adjustment of the transfer elements relative to one another possible, even when the transfer elements are short. An advantage of a cam plate compared with a cam drum lies in its flat design, so that the installation space requirement is significantly reduced. Both the cam drum and the cam plate are connected to an actuator that triggers a movement in accordance with control signals (for example, from a machine controller of a thermoforming system) in order to move the transfer elements by displacing the cam plate or drum.

In further embodiments, at least two groups of transfer elements can be displaceable separately and/or have a separate actuator, so that the spacing of the transfer elements of at least two groups of transfer elements in the particular group and/or the groups relative to one another can be individually modified. This solution offers the possibility of individually adjusting the spacings of transfer elements.

In further embodiments, each transfer element can have its own actuator, so that the spacing of the transfer elements relative to one another can be individually adjusted. This makes it possible to adjust the transfer elements independently and individually to a wide variety of cavity layouts.

In further embodiments, the transfer elements can be designed as shells.

The above-mentioned object is also achieved by a transfer station with a stacking basket for receiving thermoformed molded parts from a forming tool, where the stacking basket has multiple rows of receiving compartments for molded parts in which molded parts can be received stack by stack, a shifting unit that is designed to output stacked molded parts from the receiving compartments of the stacking basket row by row, a transfer device for transferring stacked molded parts according to one of the embodiments described above with multiple transfer elements that are arranged parallel relative to one another and are designed to in each case hold a row of stacked molded parts during a transfer, and a transport unit that has parallel-arranged receptacles for stacked molded parts, where the spacing of the transfer elements relative to one another can be modified.

The transfer station includes multiple components of a thermoforming system and makes possible the row-by-row receiving of stacked molded parts at any spacing and the transfer to the receptacles of a transport unit at a constant spacing.

In further embodiments, the spacing of the receiving compartments of at least one row of the stacking basket can be different from the spacing of the receptacles of the transport unit.

In further embodiments, the transfer device can be movable relative to the stacking basket. The transfer device can be part of a lifting system that is displaceable relative to a stacking basket in order to receive the stacks from the receiving compartments row by row. In addition, the lifting unit can be pivoted so that the transfer device can come into contact with the stacking basket, which often takes up an inclined position in thermoforming systems. For transfer to the transport unit for further processing, it may be necessary to pivot the lifting unit so that the transfer device and the transfer elements assume a substantially horizontal alignment.

The above-mentioned object is also achieved by a thermoforming system having at least one forming station for forming molded parts and a transfer station according to one of the embodiments described above.

Furthermore, the object described above is also achieved by a method for transferring thermoformed molded parts from a stacking basket to a transport unit by means of a transfer device, where the stacking basket has multiple rows of receiving compartments for molded parts that are designed to receive molded parts stack by stack, where stacked molded parts are transferred row by row from the receiving compartments of the stacking basket to a transfer device for transferring stacked molded parts via a shifting unit, where the transfer device has transfer elements arranged parallel relative to one another, which in each case hold a row of stacked molded parts during a transfer to a transport unit, where the transport unit has parallel-arranged receptacles for stacked molded parts, and where the spacing of the transfer elements relative to one another is modified after the receiving of the stacked molded parts and prior to the transfer to the transport unit.

The above designs and advantages also apply accordingly to the method for transferring thermoformed molded parts.

Further features, embodiments and advantages result from the following illustration of exemplary embodiments with reference to the figures.

### BRIEF DESCRIPTION OF THE FIGURES

In the figures:

FIG. 1 depicts a schematic representation of a thermoforming system;

FIG. 2 depicts a schematic representation of a forming process in a thermoforming system;

FIG. 3 depicts a schematic representation of a transfer station;

FIG. 4 depicts a further schematic representation of a transfer station;

FIG. 5 depicts a schematic representation of a transfer device and a stacking basket in perspective view;

FIG. 6 depicts a schematic sectional view of a transfer device;

FIG. 7 depicts a schematic representation of a cam plate with guide cams; and

FIG. 8 depicts a schematic representation of a transfer process.

### DETAILED DESCRIPTION

Various embodiments of the technical teaching described herein are shown below with reference to the figures. Identical reference signs are used in the figure description for identical components, parts and processes. Components, parts and processes that are not substantial to the technical teachings disclosed herein or that are obvious to a person skilled in the art are not explicitly reproduced. Features specified in the singular also encompass the plural unless explicitly stated otherwise. This applies in particular to statements such as “a” or “one.”

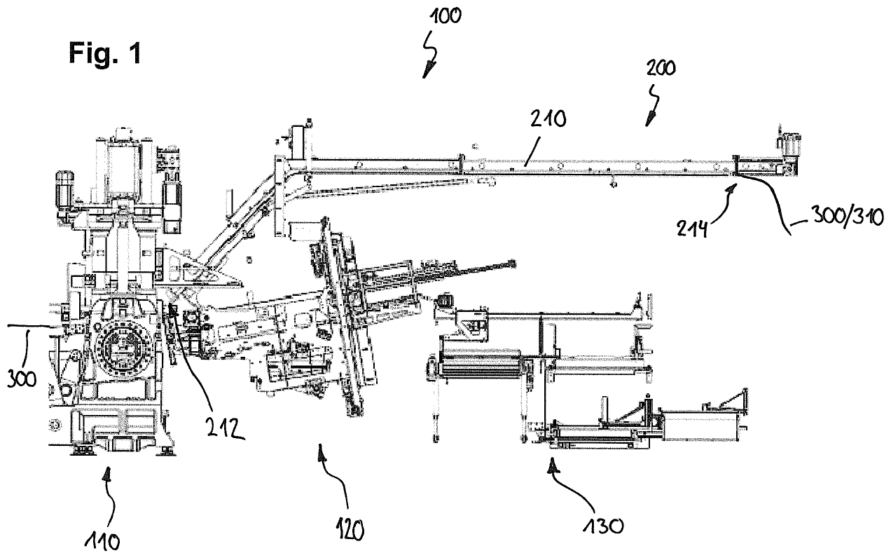

FIG. 1 depicts a schematic representation of a thermoforming system 100 for forming a moldable material that, in an exemplary embodiment shown, is fed as an endless material web from a roll. The material web can be a film made of plastic. For example, plastic films made of PET, PP, PS, PLA, PE can be processed.

The thermoforming system 100 has a heating station 110, a forming station 120, a transfer station 200 and a transport unit 130. Furthermore, the thermoforming system 100 can have further stations for pretreatment and provision of a film 300 as well as for further transport and/or further processing, which are not explicitly described in the exemplary embodiments shown.

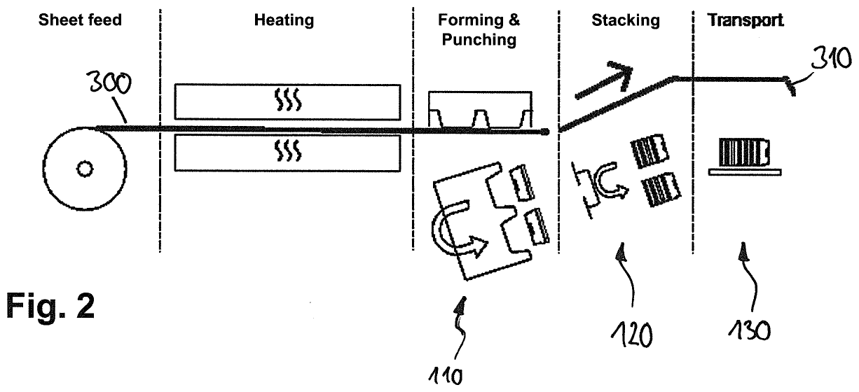

With reference to FIG. 2, which shows a schematic representation of a forming process in a thermoforming system 100, during the production of molded parts 310 in a thermoforming process, a film 300 is introduced into the thermoforming system 100 from a film feed. The film 300 is preheated in a heating station 110 and then enters the forming station 120. In the forming station 120, the film 300 is formed and punched. The formed and punched molded parts 310 from the film 300 are thereafter stacked in a stacking basket 210. Stacks 320 of molded parts 310 are transferred from the stacking basket to a transport unit 130, which further processes the stacked molded parts 310. For example, the molded parts 310 can be packed stack by stack in boxes.

The forming station 120 has a forming tool with a tiltable forming tool part and a stationary forming tool part. The tiltable forming tool part is pressed against a stationary forming tool part for forming. Subsequently, the tiltable forming tool part is moved relative to the stationary forming tool part and tilted about an axis extending substantially orthogonal to the feed direction of the film 300, where in the tilted position the formed molded parts 310, which are received in cavities of the forming tool part, are pushed into receiving compartments 212 of the stacking basket 210 via a further device, such as a so-called “picker.”

The stacking basket 210 represents the identical product pattern (layout) of the forming tool, where the receiving compartments 212 of the stacking basket 210 exhibit the same spacing and position as the cavities of the tiltable forming tool part. Therefore, formed molded parts 310 can be pushed into the receiving compartments 212, for example, via a picker plate without further difficulty. When changing the forming tool to switch to other molded parts, it may therefore be necessary to also change the stacking basket 210.

The stacks can only be passed on from the stacking basket 210 at the intervals specified by the forming tool and the spacing of the receiving compartments 212. However, receptacles 136 of a downstream transport unit 130 exhibit a specified spacing that may differ from the spacings of the cavities and the receiving compartments 212. In order to ensure an adjustment, the thermoforming system 100 has a transfer station 200 with a transfer device 220 with transfer elements 222, the spacing of which can be modified during the transfer from the receiving compartments 212 to the receptacles 136 of the transport unit 130.

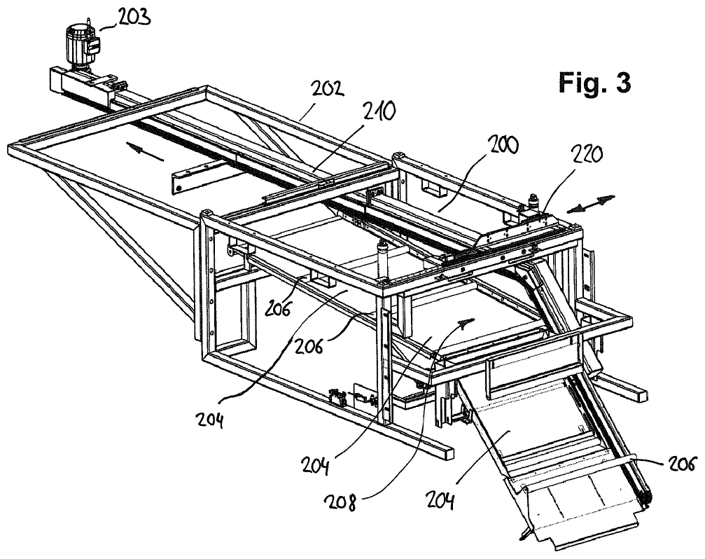

FIG. 3 depicts a schematic representation of a transfer station 200, where the stacking basket 210 is only partially shown. The stacking basket 210 exhibits an inclined alignment, so that the formed and punched-out molded parts 310 can be pushed from the lower forming tool part into the receiving compartments 212 after tilting. The transfer device 220 can be tilted in the direction of the arrow, so that the received stacks 320 can be transferred further to the transport unit 130 in a horizontal alignment. From the stacking basket 210, the stacks 320 can be pushed row by row via a so-called rake onto transfer elements 222 of the transfer device 220. The function and design of a rake are known from the prior art, so that they will not be discussed in detail here.

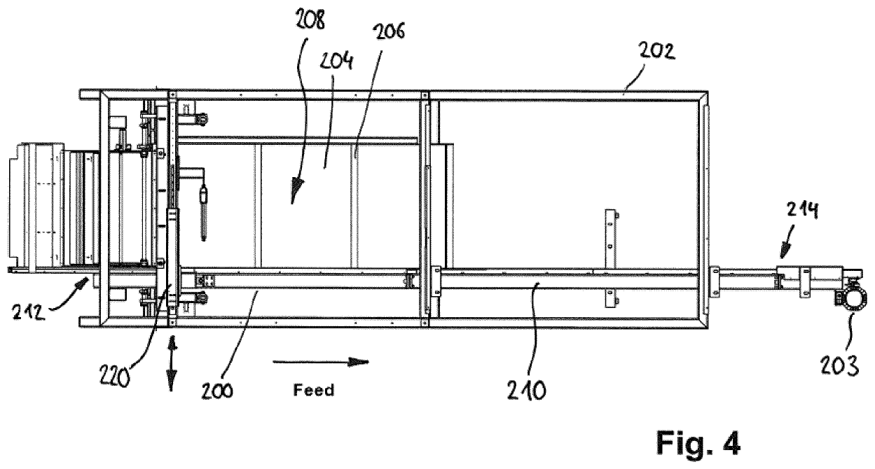

After the stacks 320 have been pushed onto the transfer elements 222, the transfer device 220 is displaced, as necessary in the embodiment shown, so that the transfer elements 222 and the receptacles 136 of the transport unit 130 are aligned relative to one another. As can be seen from FIG. 4, the stacks 320 can then be pushed out of the receiving compartments 212 via the rake and directly onto the receptacles

The spacing of the transfer elements 222 in FIG. 4 already corresponds to the spacing of the receptacles 136. The spacing of the receptacles 136 cannot be modified. In addition, it is not desired and not sensible to modify the spacing of the receptacles 136 in order to ensure reliable further processing, where the stacks 320 can always be transported further in a defined position.

In the embodiment of FIGS. 3 and 4, a design of the transport unit 130 with a sliding unit 134 is shown. The sliding unit 134 is shiftable on a frame 132 along a telescopic rail 139 in the direction of the arrow. The sliding unit 134 has a slider 138 that can be shifted over the sliding unit 134 in order to engage behind stacks 320 on the transfer elements 222 on the left side (FIG. 3) and then push them onto the receptacles 136 by displacement to the right. For this purpose, the slider 138 is additionally pivotable, as indicated by the arrow in FIG. 3, so that when passing over the stack 320 on the transfer elements 222, the slider 138 does not collide with the molded parts 310. Only after passing over is the slider 138 pivoted in order to reach behind the stack 320 and displace it to the right. The width of the slider 138 can vary, where in the embodiment shown, for example, 4 rows of stacks 320 can be simultaneously pushed onto the receptacles 136. Accordingly, it may be necessary to perform multiple shifting operations in order to push all stacks 320 from the transfer device 220 onto the transport unit 130.

Stacks 320 can also be pushed from the receptacles 136 into the right-hand region of FIG. 3 via the sliding unit 134, in which devices not shown can be provided for further processing. In further embodiments, the transfer of stacks 320 from the transfer elements 222 to the receptacles 136 can be carried out simultaneously with the transfer of further stacks 320 that lie on the receptacles 136, which are equipped with the stacks 320 to be transferred. For this purpose, the shifting unit 134 has a second slider, which is arranged in parallel at a distance from the slider 138 and is shiftable together therewith, so that, when stacks 320 are shifted from the transfer elements 222, the stacks 320 are simultaneously shifted onto the receptacles 136.

Since the transfer of the stacks 320 from the receiving compartments 212 can only take place row by row and the position of the transport unit 130 is not modified, the transfer device 220 is additionally movable in height, as indicated in FIG. 3.

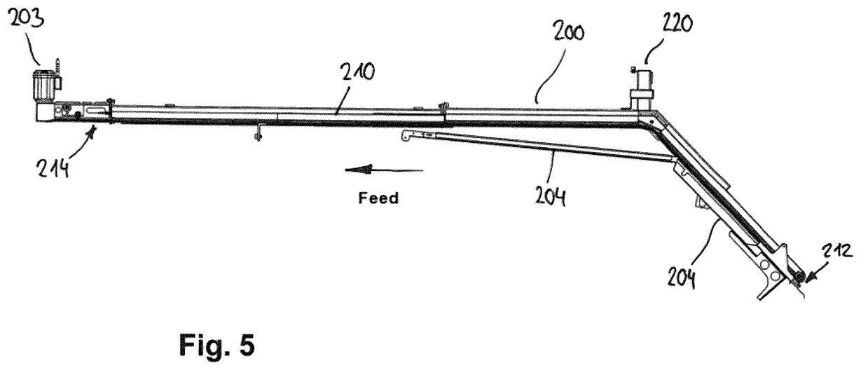

FIG. 5 depicts a schematic representation of the transfer device 220 and a part of a stacking basket 210 in a perspective view. The representation schematically shows the alignment of the transfer elements 222 relative to the receiving compartments 212, so that stacks 320 can be pushed straight from the receiving compartments 212 onto the transfer elements 222 via a rake (not shown), because the spacing of the transfer elements 222 substantially corresponds to the spacing of the receiving compartments 212.

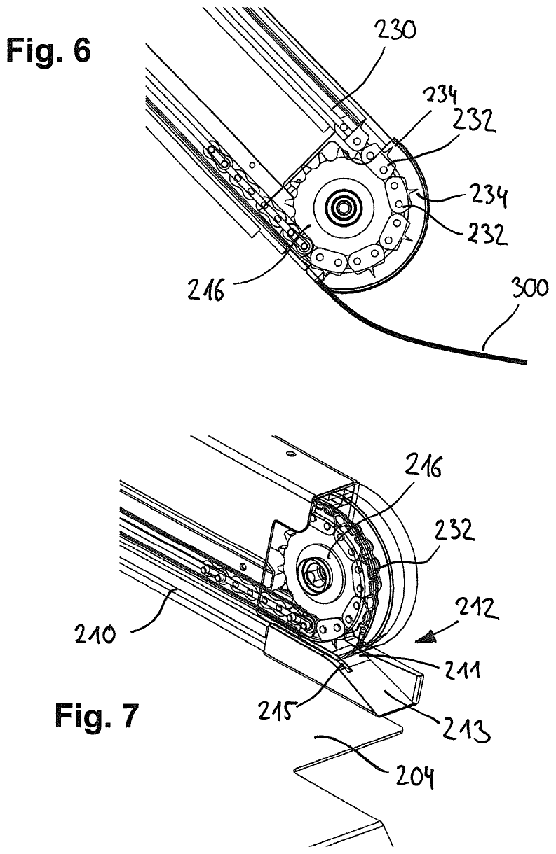

The transfer elements 222 are designed like a shell so that stacks 320 of molded parts 310 can be securely and centrally held and transferred. The transfer elements 222 are in each case connected to a carrier 232 (see, for example, FIG. 6). The sectional representation in FIG. 6 shows the structure of the transfer device 220 by a transfer element 222.

The carriers 232 have guide elements via which the carriers 232 and thus the transfer elements 222 can be shifted along two guides 230 extended in parallel. Brackets 234 are arranged on the underside of the carriers 232. The brackets 234 each have a guide element 236 that is received in a guide cam 242 of a cam plate 240. The cam plate 240 is arranged along a plate guide 244 on both sides of the transfer device 220 on its frame. At the underside, the cam plate 240 is connected to a carriage 252. The carriage 252 is shiftable linearly along a guide rail 254, parallel to the plate guide 244. The carriage 252 can be moved via a linear actuator 250. A displacement of the carriage 252 and thus of the cam plate 240 causes a displacement of the guide elements 236 and thus of the carriers 232 and the transfer elements 222 in accordance with the design of the particular guide cams 242. A possible design of a cam plate 240 and the guide cams 242 is shown in FIG. 7.

In the exemplary embodiment shown, the guide cams 242 are provided as grooves. The course of the guide cams 242 among one another can be different, as shown in FIG. 7, where it is ensured that during the displacement of the cam plate 240 from an initial position for receiving stacks 320 in the immediate vicinity of the stacking basket 210 (FIG. 5) into a transfer position, in which the stacks 320 are transferred to the receptacles 136 of the transport unit 130, the spacing of the transfer elements 222 remains the same. This means that the spacing of the transfer elements 222 is indeed reduced or increased during the transfer from one position to the other, but the decrease or increase in the spacing occurs evenly. In the two positions (end positions), the transfer elements 222 always exhibit a different spacing relative to one another in order to ensure the transfer of stacks between stations or units with different spacings. In further embodiments, the spacing of the transfer elements 222 among one another can also be different during the transfer. In further embodiments, the spacing of the transfer elements 222 among one another in the transfer position can also be different. The guide cams 242 are to be designed so that the required spacing for transfer to receptacles 136 of the transport unit 130 is achieved.

After the transfer of the stack 320 to the transport unit 130, the cam plate 240 is moved back to the initial position via the linear actuator 250, where the transfer elements 222 automatically resume the original spacing, which corresponds to the spacing of the receiving compartments 212 of the stacking basket 210.

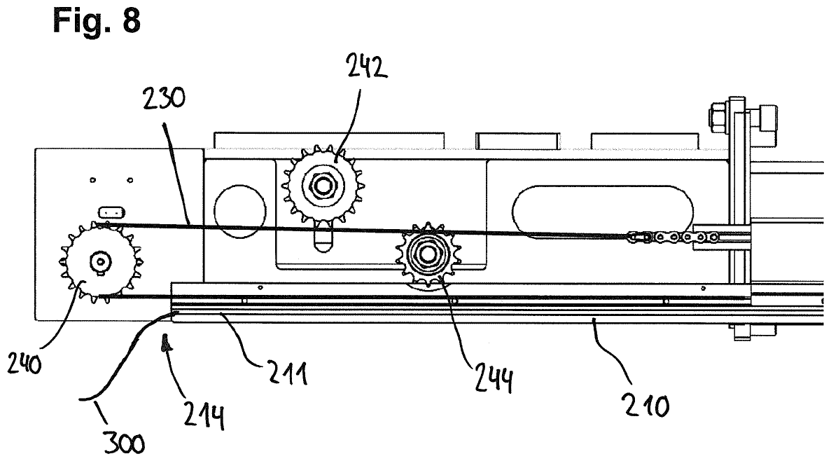

FIG. 8 depicts a schematic representation of a transfer process that illustrates the concept of the technical teaching disclosed herein. Stacks 320 of molded parts 310 are received in a stacking basket 210 at a defined spacing (I.) and can be transferred to the transfer device 220 at their predefined spacing (II.). For the transfer to a transport unit 130 with shell-like receptacles 136, which exhibit a defined spacing, the spacing of the transfer elements 222 must therefore be adjusted. The spacing is adjusted during the transfer between stacking basket 210 and transport unit 130 by linear displacement of the cam plate 240 (III.). When the cam plate 240 is displaced, the transfer elements 222 are forcibly moved according to the course of the guide cams 242. The stacks 320 then exhibit the required spacing for the transfer to the receptacles 136 and can then be transferred. In the transport unit 130, further transport then takes place for downstream processing (IV). After the transfer, the transfer elements 222 are returned to their initial position with the specified spacing in a corresponding manner, so that stacks 320 can again be received from the stacking basket 210.

The design of the guide cams 242 makes it possible to provide a secure transfer for a plurality of molded-part dimensions, where the spacing of the transfer elements 222 is adjustable. In further embodiments, the guide cams 242 can be designed in such a way that multiple spacings are represented for different molded parts 310, where, depending on the type and dimension of the molded part 310, the cam plate 240 is moved, for example, for a first group of molded parts 310 only up to a part of the cam plate 140 and for at least a second group of molded parts 310, the cam plate 240 is moved completely. This means that the travel path or the length of the travel path is decisive for the displacement of the transfer elements 222 and thus the adjustment of the spacing of the transfer elements 222 relative to one another.

In further embodiments, the transfer elements 222 can also be exchangeable. In still further embodiments, instead of a linear actuator 250 and a cam plate 240, a cam drum can be provided that has guide cams 242 on its surface. By rotating the cam drum, the transfer elements 222 can also be modified accordingly and adjusted to the spacing of receptacles 136 of a transport unit 130. In still further embodiments, a separate linear actuator can also be provided for each transfer element 222, which makes it possible to individually adjust the spacing of each transfer element 222 from adjacent transfer elements 222.

### LIST OF REFERENCE SIGNS

100 Thermoforming system
110 Heating station
120 Forming station
130 Transport unit
132 Frame
134 Sliding unit
136 Receptacle
138 Slider
139 Rail
200 Transfer station
210 Stacking basket
212 Receiving compartment
220 Transfer device
222 Transfer element
230 Guide
232 Carrier
234 Bracket
236 Guide element
240 Cam plate
242 Guide cam
244 Plate guide
250 Linear actuator
252 Carriage
254 Guide rail
300 Film
310 Molded part
320 Stack

1. A transfer device for transferring parallel-arranged rows of stacked molded parts, the transfer device having multiple transfer elements that are arranged parallel relative to one another and are configured to in each case hold a row of stacked molded parts during a transfer, wherein a spacing of the transfer elements is configured to be modified during the transfer between a receiving of rows of stacked molded parts and a transfer of rows of stacked molded parts.

2. The transfer device according to claim 1, wherein the spacing of the transfer elements is configured to be uniformly modified.

3. The transfer device according to claim 1, wherein the spacing of the transfer elements relative to one another is configured to be variably modified.

4. The transfer device according to claim 1, further comprising a cam guide, wherein the transfer elements in each case have a guide element that is received in a corresponding guide of the cam guide, and wherein the cam guide is displaceable in order to adjust the spacing of the transfer elements in accordance with the corresponding guide by the displacement.

5. The transfer device according to claim 4, further comprising a cam plate that has the cam guide and is linearly displaceable via at least one actuator.

6. The transfer device according to claim 4, further comprising a cam drum whose surface has the cam guide and that is rotatably mounted via at least one actuator.

7. The transfer device according to claim 1, wherein at least two groups of transfer elements are separately displaceable and/or have a separate actuator, such that the spacing of the transfer elements of at least two groups of transfer elements in a particular group and/or the groups relative to one another are configured to be individually modified.

8. The transfer device according to claim 1, wherein each transfer element has its own actuator, such that the spacing of the transfer elements relative to one another is configured to be individually adjusted.

9. The transfer device according to claim 1, wherein the transfer elements are designed as shells.

10. A transfer station with a stacking basket for receiving thermoformed molded parts from a forming tool, wherein the stacking basket has multiple rows of receiving compartments for molded parts in which molded parts can be received stack by stack, a shifting unit that is configured to output stacked molded parts from the receiving compartments of the stacking basket row by row, a transfer device for transferring stacked molded parts with multiple transfer elements that are arranged parallel relative to one another and are configured to in each case hold a row of stacked molded parts during a transfer, and a transport unit that has parallel-arranged receptacles for stacked molded parts, wherein a spacing of the transfer elements relative to one another is configured to be modified.

11. The transfer station according to claim 10, wherein a spacing of the receiving compartments of at least one row of the stacking basket is different from a spacing of the receptacles of the transport unit.

12. The transfer station according to claim 10, wherein the transfer device is movable relative to the stacking basket.

13. The transfer station according to claim 10, wherein the transfer station is part of a thermoforming system having at least one forming station for forming molded parts and the transfer station.

14. A method for transferring thermoformed molded parts from a stacking basket to a transport unit using a transfer device, wherein the stacking basket has multiple rows of receiving compartments for molded parts that are configured to receive molded parts stack by stack, wherein stacked molded parts are transferred row by row from the receiving compartments of the stacking basket to a transfer device for transferring stacked molded parts via a shifting unit, wherein the transfer device has transfer elements arranged parallel relative to one another, which in each case hold a row of stacked molded parts during a transfer to a transport unit, wherein the transport unit has parallel-arranged receptacles for stacked molded parts, and wherein a spacing of the transfer elements relative to one another is modified after the receiving of the stacked molded parts and prior to the transfer to the transport unit.
